(19) United States
(12) Patent Application Publication
(10) Pub. No.: US 2025/0196960 A1
(43) Pub. Date: Jun. 19, 2025

(54) Bicycle with Lock

(71) Applicant: MA MICRO LIMITED, London (GB)

(72) Inventors: Thijs Faber, London (GB); Zhan Jun Lin, London (GB); Mykola Zaitsev, London (GB); Yu-Lun Chao, London (GB); David Alexander Enthoven, London (GB); Olivier Hébert, London (GB); Ahmet Serhan Kuscuoglu, London (GB); Chien-Cheng Kung, London (GB)

(21) Appl. No.: 18/848,648

(22) PCT Filed: Mar. 20, 2023
(86) PCT No.: PCT/NL2023/050141

§ 371 Date: Sep. 19, 2024

(30) Foreign Application Priority Data
Mar. 21, 2022 (NL) 2031358

(51) Int. Cl. B62J 45/20; B62H 5/00; B62J 45/412; B62J 50/22; G01D 5/14

(52) U.S. Cl. CPC B62J 45/20; B62J 45/412; B62J 50/22; G01D 5/142; B62H 5/00

(57) ABSTRACT

The present invention relates to a bicycle with a central controlling computer including a lock. The lock includes a housing, a bolt having a blocking state and an unblocking state providing a blocking action in the blocking state with which the bicycle is lockable, a channel for therein arranging of the bolt, a latch having a latching state and an unlatching state for keeping the bolt in the blocking state, and a latch actuator having a blocking state and a releasing state for blocking or releasing the latch, wherein the bolt in the blocking state is in cooperation with a receiving space defining a state of cooperation in which the bolt and the receiving space locks the bicycle, a lock control unit for controlling the lock, such as with interaction with a bolt location sensor, and for communication with the central controlling computer, wherein the lock control unit is configured to provide a release actuation signal for releasing the latch, for unlocking the lock, based on an action and/or a status of a rider of the bicycle.

### CROSS-REFERENCE TO RELATED APPLICATIONS

This application is the United States national phase of International Patent Application No. PCT/NL2023/050141 filed Mar. 20, 2023, and claims priority to The Netherlands Patent Application No. 2031358 filed Mar. 21, 2022, the disclosures of which are hereby incorporated by reference in their entireties.

### BACKGROUND OF THE INVENTION

### Field of the Invention

The present invention relates to a bicycle, in particular an electric bicycle, with a central controlling computer, such as a central board computer, for controlling subsystems of the bicycle, such as lights, a sound system, a drive motor, a battery management system and/or a security system, such as comprising a power on/off or ignition function, the bicycle comprising a lock. The invention also relates to a lock for use in a such a bicycle according to the invention.

### Description of Related Art

Bicycle locks have been a long-standing safeguard for prevention of theft of a bicycle. With PCT/NL2019/050227, the present inventor endeavored a new approach of an integrated lock in a bicycle aimed at blocking of a wheel of the bicycle in a way that is more practical to operate by a user as the user can lock the bicycle by pressing a button near the hub of the wheel. Since, the present inventor has endeavored to improve upon that concept as certain aspects were thought of to be able to be improved for the benefit of the rider of the bicycle. A reason for this is that it was considered a disadvantage that the rider needed to move the bicycle to rotate the wheels for providing an unlocking action.

### SUMMARY OF THE INVENTION

As such, it is an object of the invention to provide simplified unlocking of the bicycle wherein the unlocking action is performed by their lock device instead of by the user.

It is a further object of the invention to assist the rider with locking by providing feedback as to an actual status of the lock.

It is a further object of the invention to assist the provider with locking by providing feedback as to unsuitable orientation for locking of respective parts of the block device such as the bolt and a receiving space providing unit.

It is a further object of the invention to prevent locking when it is unwanted, such as when the bicycle is riding.

At least one of these objects can be met by providing electric bicycle with a central controlling computer, such as a central board computer, for controlling subsystems of the bicycle, such as lights, a sound system, a drive motor, a battery management system and/or a security system, such as comprising a power on/off or ignition function, the bicycle comprising at least one lock, such as a wheel lock and/or crankshaft lock and/or steering lock, the lock comprising:
a housing,
at least one locking element and/or at least one bolt (locking pin) having a blocking state and an unblocking state providing a blocking action in the blocking state with which the bicycle is lockable,
preferably a channel for therein arranging of the locking element and/or bolt,
preferably at least one latch having a latching state and an unlatching state for, in the latching state of the latch, keeping the bolt in the blocking state, Preferably at least one latch actuator, such as comprising a solenoid or electric motor, having a blocking state and a releasing state for blocking or releasing the latch, preferably for blocking the latch in the latching state
wherein the bolt and/or other locking element in the blocking state is in cooperation with a receiving space of an at least one receiving space defining unit, such as a recess or opening, defining a state of cooperation in which the bolt and the receiving space locks the bicycle,
a lock control unit for controlling the lock, such as with interaction with a bolt location sensor and/or locking element location sensor, and for communication with the central controlling computer,
wherein the lock control unit is configured to provide a release actuation signal for releasing the latch, for unlocking the lock, such as by means of a bolt biasing device (and/or locking element biasing device), preferably based on an action and/or a status of a rider of the bicycle and/or other controlling user.

The bicycle according to the invention preferably comprises a central controlling computer, such as a central board computer, for controlling subsystems of the bicycle, such as lights, a sound system, a drive motor, a battery management system and/or a security system, such as comprising a power on/off or ignition function, the bicycle comprising a lock, such as a wheel lock, the lock comprising:
a housing,
a bolt having a blocking state and an unblocking state providing a blocking action in the blocking state with which the bicycle is locked,
at least one bolt spring, such as a coil spring or leaf spring, constantly co-acting with the bolt for urging the bolt towards the unblocking state, a channel for therein arranging of the bolt,
a latch having a latching state and an unlatching state for, in the latching state of the latch, keeping the bolt in the blocking state, a latch actuator, preferably comprising a solenoid or electric motor, said latch actuator having a blocking state, preferably for blocking the latch in the latching state, and a releasing state for releasing the latch,
wherein the bolt in the blocking state is in cooperation with a receiving space, such as a recess or opening, defining a state of cooperation in which the bolt and the receiving space locks the bicycle,
a lock control unit for controlling the lock and for communication with the central controlling computer,
wherein the lock control unit is configured to, based on an action and/or a status of a rider of the bicycle, provide a release actuation signal for releasing the latch to allow urging the bolt towards the unblocking state by means of said at least one bolt spring.

It is an advantage of the present invention that with the two way communication with the central controlling computer of the bicycle, better rider comfort is achieved. When for instance a rider reaches is bicycle, the bike is in a locked state. The central controlling computer of the bicycle may be informed of the presence of the rider by means of a number of inputs. At least one mobile device of the rider may identify itself with the central controlling computer via a wireless connection, such as Bluetooth, there with instantly identifying the mobile device with the central controlling computer. This presence in itself may be considered a wish to unlock the lock in a certain configuration of settings. In another configuration of settings, the rider is required to provide a confirmation of the wish to unlock the lock such as by means of a button press of a button on the bicycle that is connected with the central controlling computer. Upon the perceived wish or a confirmation of the rider to unlock block, the central controlling computer communicates with a lock control unit to unlock the lock by means of releasing the latch. Many other configurations of settings for detecting the presence of the rider and perceiving a confirmation to unlock are envisaged and indicated in the below description in further detail.

According to a first preferred embodiment, the lock comprises a bolt biasing device for biasing the bolt from the blocking state to the unblocking state. The bolt is a displaceable member within a lock that may be slidable and/or may be arranged in the channel. It is an advantage of such bolt biasing device that the bolt may be transferred, such as physically, from the blocking state to the unblocking state by the bolt biasing device. This provides the advantage over the said prior art that the lock will unlock based on the perceived wish or a confirmation of the rider without the bolt remaining in the blocking position.

Preferably, the lock control unit is configured to, preferably based on an action and/or a status of a rider of the bicycle, provide a release actuation signal for releasing the latch to allow urging the bolt towards the unblocking state by means of said at least one bolt spring. Hence, the spring force of the at least one bolt spring urges the bolt towards and into the unblocking state (once released by the latch). The spring-loaded bolt (locking pin) facilitates unlocking the bicycle and does not require e.g. that the bicycle wheel has to push the bolt towards the unblocking state, which would lead to wear and possibly damaging of components of the bicycle.

Hence, according to a further preferred embodiment, the biasing device comprises at least one spring, such as a coil spring or leaf spring, and/or an electrically driven actuator. Such embodiment provides an advantageous simple and functional bias of the bolt. An advantage of a coil spring is that it can be arranged around a cylindrical part of the bolt thereby limiting space requirements in the lock.

According to a further preferred embodiment, the lock comprises a sensor providing sensor signals for detecting a position of the bolt relative to the sensor, preferably of a magnetizable or magnetized part of the bolt, such as a magnet arranged at the bolt. With this, it is advantageous that the communication between the lock control unit and the central computer of the bike is a two-way communication. With this input of the position of the bolt relative to the sensor, specific advantages may be achieved. One of the advantages is that positions of the bolt, such as being in the unblocking state such as fully retracted, being in the blocking state, such as regularly pushed in and engaged with the latch, such as being fully pushed in by the rider, such as by hand or foot or being slightly pushed out by rotation of the wheel by means of the space defining unit or a space wall thereof. Operational advantages and interpretations of such states will be described below in further detail.

According to a further preferred embodiment, the bicycle comprises at least one sensor (or sensor part) configured to provide and/or generate sensor signals for detecting a position of the receiving space and/or the bolt (and/or another component of the lock) relative to the sensor. The sensor is preferably mounted onto and/or within the housing, and/or may form part of the lock control unit. The sensor may for example be a Hall effect sensor (or simply Hall sensor), preferably a 3D Hall sensor, configured to detect the presence and/or magnitude of a surrounding magnetic field using the Hall effect. The output voltage of a Hall sensor is directly proportional to the strength of the field. The output voltage is preferably fed to the lock control unit and/or processed by the lock control unit and/or the central processing unit to determine the absolute and/or relative position of the receiving spaces and/or the bolt, such as with respect to the housing, and/or to determine the number of revolutions per minute (rpm) of the receiving spaces which is indicative for the bicycle speed. To this end, one or more receiving spaces and/or the bolt preferably comprises a magnetizable, and/or a magnetized part, and/or at least one magnet. A relative displace of the receiving spaces and/or the bolt with respect to said at least one sensor, in particular hall sensor, will be detected and can be used as bicycle and/or lock related information, as feedback for the user and/or for controlling the bicycle and/or the lock.. With this, it is advantageously achieved to allow, for example, feedback to the user as to whether the bolt is aligned with a receiving space or whether the bolt is misaligned relative to two adjacent receiving spaces. This advantageously provides the option of providing such feedback during operating of the bolt by the user and/or the exact position and/or exact state of the bolt. In combination with the previous preferred embodiment, it is advantageously achieved that such feedback is only provided during an operation or an attempt to kick in the bolt by the user as it is both possible to detect movement of the bolt from the completely retracted position or unblocking state and of a respective receiving space for the bolt to be displaced into or for a lack of such a respective receiving space for the bolt to be blocked by. As such, it is both possible to provide a positive feedback indicating that locking by displacing the bolt is possible by the mutual arrangement of the receiving space and the bolt or is hampered by mutual arrangement of the receiving space as the bolt.

According to a further preferred embodiment, the bicycle comprises a single sensor, such as a hall sensor, preferably a 3D Hall sensor comprising the sensor for detecting a position of the bolt and the sensor for detecting a position of the receiving space, preferably wherein the sensor is capable of detecting signals along at least two directions in a 3D space. With the use of such a sensor, it is advantageously achieved that in a single sensor can perform both sensor functions for sensing the location of the bolt and sensing the location of a respective receiving space.

It may be preferred to apply an anti-magnetic foil, coating or layer onto one or more electronic and/or magnetic parts of the lock or the bicycle, other than the bolt and/or receiving space(s), to prevent that these electronic and/or magnetic parts will affect and/or influence the signal measured by the sensor, in particular the hall sensor.

According to a further preferred embodiment, the latch is a hinging latch hinging about a pivot, preferably with one or two bearings. This provides the advantage of relatively high freedom of arranging a cam actuator. Such a hinging latch further provides the advantage of better resilience relative to exerted forces. Preferably, the pivot (i.e. the pivoting point of the latch) is situated in between in the latch actuator and the bolt. Such a positioning of the pivot facilitates to use the hinging latch to act as lever. Preferably, the pivot divides the latch into a latch actuator facing section and a bolt facing section, wherein the length of said latch actuator facing section exceeds the length bolt facing section. Such an asymmetrically positioned pivot makes it possible to provide the hinging latch with a favourable momentum facilitating rotation (hinging) of the latch by the latch actuator, while making it more difficult for the bolt to rotate the latch. Hence, this will facilitate actuation of the latch, while at the same time allowing the latch to lock the bolt in the blocking state in a more robust and reliable manner. This embodiment furthermore provides more freedom in positioning the latch actuator and/or components of the latch actuator, which provides more freedom of design of the lock as such. Preferably, the pivot has a pivot axis which runs substantially parallel with a longitudinal axis of the bolt and/or a displacement direction of the bolt. The latch is preferably orientation substantially parallel to an adjacent bicycle wheel, which leads to a relatively compact design of the lock. Preferably, the maximum rotation angle of the hinge arounds its pivot is limited to 30 degrees, preferably 25 degrees, more preferably 20 degrees. The maximum rotation and/or displacement of the latch, preferably for limiting and defining the unlatched state of the latch, be realized by means of the housing and/or by means of one or more limitation cams, which preferably make part of the housing and/or are mounted onto or within the housing.

Further preferably, the latch actuator is generally substantially directed at the bolt along a heart-line thereof, preferably wherein the bolt, latch and latch actuator substantially form a linear arrangement. This provides the advantage that the combination of latch and latch actuator may be arranged in a limited volume as opposed to the said prior art is a disadvantageous L-shaped arrangement required relatively large space.

According to a further preferred embodiment, the latch is provided is provided with a latch biasing device, preferably comprising a spring, for biasing the latch towards the unlatching state. This latch biasing device achieves that the latch is continuously biased towards the unlatching or unlatching state, preferably towards the unlatching state. With this, the latch actuator may simply lock into place keeping the latch in the latching state unless it is controlled to release the latch. To this end, it is preferred that the latch actuator is biased towards the blocking state thereof. It is furthermore preferred that the latch actuator is brought to the releasing state thereof during all times that the lock is supposed to be opened or kept open. The letter achieves that the latch is always capable of being biased to the latching state such that the lock remains open. This is further detailed in the description below.

According to a further preferred embodiment, the bicycle comprises at least one processor configured to, such as with program code operational on the lock control unit or the central controlling computer, monitor the sensor signals and functional to interpret the sensor signals as input for locking instructions or unlocking instructions. It is presently preferred that is processor function is operational in the lock control unit. Such processor function provides the advantage of allowing constant knowledge by the lock control unit and via communications by the central controlling computer of the bicycle whether the lock is locked, open or be incorporated in some way, such as including pressing the bolt, or rotating the wheel providing indication that the user wishes the lock to be opened.

According to a further preferred embodiment, such sensor signals are preferably interpreted such that the bolt is respectively determined to be:
in the unblocking state when the position of the locking pin is fully retracted, such as having a value of substantially 100,
in the blocking state when the position of the locking pin is held by the latch when the latch is in the latched state, such as having a value of substantially 9,
in a fully pressed in state, when the lock pin is in a fully pressed in state during a press in operation by a rider, such as having a value of substantially 0,
in a wheel rotation induced, such as heightened, state, such as having a value between 10 and 20.
according to a further preferred embodiment, such sensor signals are interpreted such that the receiving space is respectively determined to be:
aligned with the bolt such as in a position to allow the bolt to be pressed into the receiving space, such as having a value of substantially 0,
misaligned with the bolt such as in a position to prevent the bolt to be pressed into the receiving space,
in an intermediary position between aligned and misaligned such as caused by wheel rotation, such as having a value of substantially between 0 and 30.

Such interpretations of the sensor signal, and the use thereof are elucidated in further detail in the below description.

According to a further preferred embodiment, the central controlling computer comprises a receiving module for receiving of user input and/or bicycle speed related input, wherein the central controlling computer is configured to communicate with and/or to instruct the lock control unit based upon the input received. Preferably, the central controlling computer comprises a receiving module for receiving of user input, such as from a control button, bolt press, bicycle speed, such as due to motor rotation, or app input that is provided from an app operational on a mobile device of the user as input for locking instructions or unlocking instructions. Such parameters thus advantageously provide user input or status information relating to the bicycle. Such user input provides information as to the wish or operations of the user relative to the lock. Such status information provides information as to status situations of the bicycle. It is generally advantageous to prevent location of the bike when the bicycle has a speed. In such case, in case of a blocking action by a person on the bolt, the lock control unit can control the latch actuator to immediately release the latch.

According to a further preferred embodiment, the bicycle comprises at least one processor, such as with program code operational on the central controlling computer, arranged for assembling locking instructions or unlocking instructions based on a combination of sensor signals as input or user input, such as:
an unlocking instruction in case of a respective user input,
an unlocking instruction in case of a respective user input in combination with a sensor input, such as with a determination that the bolt leaves the unblocking state, preferably with a determination that the speed of the bicycle, such as motor speed is substantially 0, and/or
an unlocking instruction in case of a user input in combination with a sensor input, such as with a determination that the wheel rotation induced state is detected.

It is preferred that such instructions are assembled by the central controlling computer controlling all subsystems of the bicycle and receiving all user input such as corporations, button presses, pedaling operations that provide the central controlling computer with all information as to what actions need to be performed by what subsystems of the bicycle. It is thus specifically advantages that the central control computer also controls the locking of the bicycle when the user either stops riding or leaves the bicycle alone in an uncontrolled environment.

According to a further preferred embodiment, the bicycle comprises at least one feedback device for providing rider feedback based on sensor information and/or lock related information, such as audible and/or visible feedback, feedback by a display or feedback via and app that is functional on a mobile device of the rider. With this, it is advantageously achieved that the rider is immediately informed of either the status of the lock or the status of an operation the rider wishes to perform with the lock, such as locking or unlocking. It is advantageous that a rider can see and/or hear that the lock can be immediately locked by kicking the bolt because the bolt is at a good location relative to a receiving space. In a similar way it is advantages that the rider can see and/or hear when the lock cannot immediately be locked by kicking the bolt because the bolt is not at a good location relative to a receiving space.

According to a further preferred embodiment, the rider feedback comprises feedback as to correctly locking of the bicycle lock, no locking of the bicycle lock due to a misalignment of the bolt with the receiving space, correctly unlocking of the bicycle lock, and/or not unlocking of the bicycle lock.

Preferably, the lock comprises at least one locking plate, in particular at least one locking disk, fixedly attached, either directly or indirectly, to a wheel of the bicycle, preferably a rear wheel of the bicycle, wherein the locking plate comprises a plurality of bolt receiving spaces mutually separated by blocking bodies arranged on said locking plate. Once the bolt is (partially) positioned in a receiving space, full rotation of the wheel is no longer possible due to the interaction between the bolt and the blocking bodies, which locks the bicycle. Preferably, each blocking body is provided with inclined side walls facing adjacent receiving spaces to facilitate guiding of the bolt into a receiving space. These tapered sides walls (inclined side walls) thus act us guiding surface to facilitate displacement of the bolt into the blocking state. Preferably, the bolt has a tapered end section facing the at least one receiving space to facilitate guiding of the bolt into a receiving space. More preferably, the tapered end section matches the inclination of the side walls of the blocking bodies to allow smooth sliding of the end section of the bolt of the inclined side walls of the blocking bodies.

Preferably, an end section of the latch, facing the bolt, has an inclined bolt contact surface with respect to a longitudinal axis of the bolt and/or a displacement direction of the bolt. Preferably, the bolt has an inclined latch contact surface with respect to a longitudinal axis of the bolt and/or a displacement direction of the bolt. More preferably, the inclination of the bolt contact surface and the latch contact surface with respect to a longitudinal axis of the bolt and/or a displacement direction of the bolt is substantially identical. The bolt preferably has at least one widened end portion, preferably two widened end portions at opposite ends, and at least one narrower portion in between. This narrower intermediate portion is preferably applied to create an accommodating space for the latch (in the latched state). A transition from a widened end section, preferably a widened end section facing an adjacent wheel of the bicycle, to said narrow intermediate portion is preferably angle and/or conically shaped to form said latch contact surface of the bolt.

Preferably, the latch comprises a latch actuator contact surface, which runs substantially parallel with a longitudinal axis of the bolt and/or a displacement direction of the bolt. Hence, the opposing contact surfaces of the latch, in particular the actuator contact surface and the bolt contact surface are preferably have a mutually twisted orientation.

Preferably, at least one bolt spring co-acts with a stationary part of the lock, such as a the housing, preferably both in the blocking state and in the unblocking state of the bolt. Preferably, the bolt spring co-acts with a rear side of an end section of the bolt which is exposed to a user to allow said user to displace the bolt (preferably by using his foot).

Preferably, the bolt spring itself is not exposed.

Further preferred embodiment of the invention are set out in the non-limitative set of embodiments presented below:
1. Bicycle with a central controlling computer, such as a central board computer, for controlling subsystems of the bicycle, such as lights, a sound system, a drive motor, a battery management system and/or a security system, such as comprising a power on/off or ignition function, the bicycle comprising a lock, such as a wheel lock, the lock comprising:
   a housing,
   a bolt having a blocking state and an unblocking state providing a blocking action in the blocking state with which the bicycle is lockable,
   a channel for therein arranging of the bolt,
   a latch having a latching state and an unlatching state for, in the latching state of the latch, keeping the bolt in the blocking state,
a latch actuator, such as comprising a solenoid or electric motor, having a blocking state and a releasing state for blocking or releasing the latch, preferably for blocking the latch in the latching state
   wherein the bolt in the blocking state is in cooperation with a receiving space, such as a recess or opening, defining a state of cooperation in which the bolt and the receiving space locks the bicycle,
   a lock control unit for controlling the lock, such as with interaction with a bolt location sensor, and for communication with the central controlling computer,
   wherein the lock control unit is configured to provide a release actuation signal for releasing the latch, for unlocking the lock, such as by means of a bolt biasing device, based on an action and/or a status of a rider of the bicycle.
2. Bicycle according to embodiment 1, the lock comprising a bolt biasing device for biasing the bolt from the blocking state to the unblocking state.
3. Bicycle according to any of the embodiments 2 wherein the biasing device comprises at least one spring, such as a coil spring or leaf spring, and/or an electrically driven actuator.
4. Bicycle according to embodiment 1, 2 or 3, the lock comprising a sensor providing sensor signals for detecting a position of the bolt relative to the sensor, preferably of a magnetizable or magnetized part of the bolt, such as a magnet arranged at the bolt.
5. Bicycle according to any of the preceding embodiments comprising a sensor providing sensor signals for detecting a position of the receiving space relative to the sensor, preferably of a magnetizable or magnetized part of the receiving space, such as a magnet arranged in the receiving space.
6. Bicycle according to embodiment 4 or 5 comprising a single sensor, such as a hall sensor, preferably a 3D Hall sensor comprising the sensor for detecting a position of the bolt and the sensor for detecting a position of the receiving space, preferably wherein the sensor is capable of detecting signals along at least 2 directions in a 3D space.
7. Bicycle according to any of the preceding embodiments wherein the latch is a hinging latch hinging about a pivot, preferably with one or two bearings.
8. Bicycle according to any of the preceding embodiments wherein the latch is provided with a latch biasing device, preferably comprising a spring, for biasing the latch towards the unlatching state.
9. Bicycle according to any of the preceding embodiments in which the latch actuator is generally substantially directed at the bolt along a heart-line thereof, preferably wherein the bolt, latch and latch actuator substantially form a linear arrangement.
10. Bicycle according to any of the embodiments of 3-9, comprising at least one processor configured to, such as with program code operational on the lock control unit or the central controlling computer, monitor the sensor signals and functional to interpret the sensor signals as input for locking instructions or unlocking instructions.
11. Bicycle according to embodiment 10 in which the sensor signals are interpreted such that the bolt is respectively determined to be:
   in the unblocking state when the position of the locking pin is fully retracted, such as having a value of substantially 100,
   in the blocking state when the position of the locking pin is held by the latch when the latch is in the latched state, such as having a value of substantially 9,
   in a fully pressed in state, when the lock pin is in a fully pressed in state during a press in operation by a rider, such as having a value of substantially 0,
   in a wheel rotation induced, such as heightened, state, such as having a value between 10 and 20.
12. Bicycle according to embodiment 10 or 11 in which the sensor signals are interpreted such that the receiving space is respectively determined to be:
   aligned with the bolt such as in a position to allow the bolt to be pressed into the receiving space, such as having a value of substantially 0,
   misaligned with the bolt such as in a position to prevent the bolt to be pressed into the receiving space,
   in an intermediary position between aligned and misaligned such as caused by wheel rotation, such as having a value of substantially between 0 and 30.
13. Bicycle according to any of the preceding embodiments wherein the central controlling computer comprises a receiving module for receiving of user input, such as from a control button, bolt press, bicycle speed, such as due to motor rotation, or app input that is provided from an app operational on a mobile device of the user as input for locking instructions or unlocking instructions.
14. Bicycle according to any of the preceding embodiments comprising at least one processor, such as with program code operational on the central controlling computer, arranged for assembling locking instructions or unlocking instructions based on a combination of sensor signals as input or user input, such as:
   an unlocking instruction in case of a respective user input,
   an unlocking instruction in case of a respective user input in combination with a sensor input, such as with a determination that the bolt leaves the unblocking state, preferably with a determination that the speed of the bicycle, such as motor speed is substantially 0, and/or
   an unlocking instruction in case of a user input in combination with a sensor input, such as with a determination that the wheel rotation induced state is detected.
15. Bicycle according to any of the preceding embodiments comprising at least one feedback device for providing rider feedback based on sensor information, such as audible and/or visible feedback, feedback by a display or feedback via and app that is functional on a mobile device of the rider.
16. Bicycle according to embodiment 15 wherein the rider feedback comprises feedback as to correctly locking of the bicycle lock, no locking of the bicycle lock due to a misalignment of the bolt with the receiving space, correctly unlocking of the bicycle lock, and/or not unlocking of the bicycle lock.
17. Bicycle according to one of the preceding embodiments, wherein the lock comprises at least one locking plate, in particular locking disk, fixedly attached, either directly or indirectly, to a wheel of the bicycle, preferably a rear wheel of the bicycle, wherein the locking plate comprises bolt receiving spaces mutually separated by blocking bodies arranged on said locking plate.
18. Bicycle according to embodiment 17, wherein each blocking body is provided with inclined side walls facing adjacent receiving spaces to facilitate guiding of the bolt into a receiving space.
19. Bicycle according to one of the preceding embodiments, wherein the bolt has a tapered end section facing the at least one receiving space to facilitate guiding of the bolt into a receiving space.
20. Bicycle according to one of the preceding embodiments, wherein an end section of the latch, facing the bolt, has an inclined bolt contact surface with respect to a longitudinal axis of the bolt and/or a displacement direction of the bolt.
21. Bicycle according to one of the preceding embodiments, wherein the bolt has an inclined latch contact surface with respect to a longitudinal axis of the bolt and/or a displacement direction of the bolt.
22. Bicycle according to embodiment 20 and 21, wherein the inclination of the bolt contact surface and the latch contact surface with respect to a longitudinal axis of the bolt and/or a displacement direction of the bolt is substantially identical.
23. Bicycle according to one of the preceding embodiments, wherein the latch comprises a latch actuator contact surface, which runs substantially parallel with a longitudinal axis of the bolt and/or a displacement direction of the bolt.
24. Bicycle according to one of the preceding embodiments, wherein at least one bolt spring co-acts with a stationary part of the lock, such as a the housing, preferably both in the blocking state and in the unblocking state of the bolt.
25. Bicycle according to one of the preceding embodiments, wherein the lock control unit and the central processing unit are configured for two-way communication with each other.
26. Lock for use in a bicycle according to any of the preceding embodiments.

### BRIEF DESCRIPTION OF THE DRAWINGS

The terms Fig., Figs., Figure, and Figures are used interchangeably in the specification to refer to the corresponding figures in the drawings.

Further advantages, features and details of the present invention will be further elucidated on the basis of a description of one or more preferred embodiments with reference to the accompanying figures. Similar yet not necessarily identical parts of different preferred embodiments may be indicated with the same reference numerals.

FIG. 1 relates to a perspective view of a first preferred embodiment according to the present invention.

FIG. 2 relates to a detail of the preferred embodiment according to the present invention.

FIGS. 3A-B relate to perspective views of details of a further preferred embodiment.

FIGS. 4A-B relate to a perspective view and a side view of a further preferred embodiment.

FIGS. 5A-B relate to a schematic representation of a further preferred embodiment.

FIG. 6 relates to a schematic representation of a further preferred embodiment.

FIGS. 7A-B relate to a sensor signal graph and a perspective view indicating the location of such sensor in a preferred embodiment.

FIG. 8 relates to a schematic representation of a further preferred embodiment.

FIG. 9 provides a general representation of a bicycle equipped with a preferred embodiment according to the present invention.

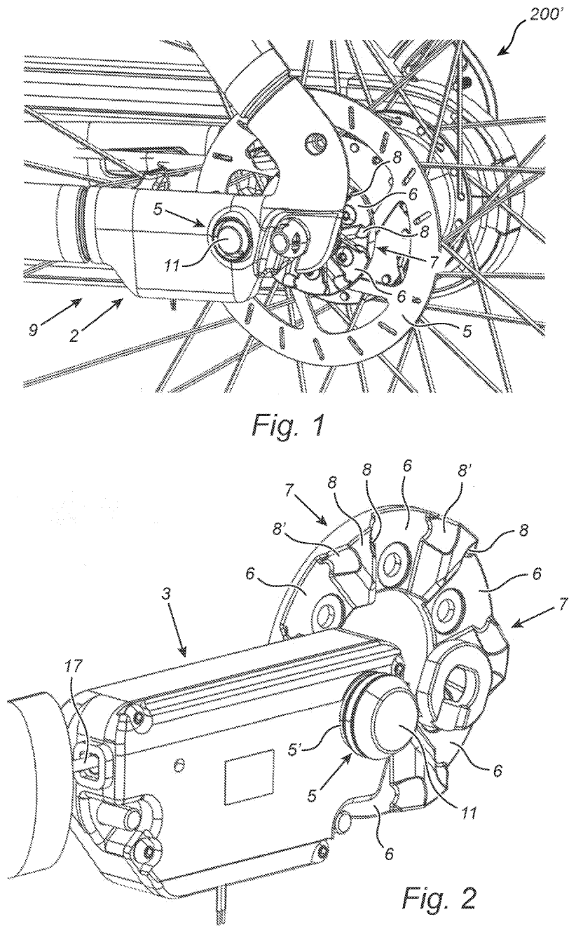

### DESCRIPTION OF THE INVENTION

A first preferred embodiment according to the present invention relates to a lock 2, such as a bicycle lock, such as a wheel lock of a bicycle 200′. The lock is generally arranged at the axle of the bicycle and an end part 9 of a bottom stay, preferably the left one, of the bicycle. The lock comprises a disk 7 (locking plate) that is generally arranged at the of the wheel, preferably intellectual with the axle of the bicycle. The disk 7 is preferably mounted to a brake disc S of the bicycle. The disk 7 comprises spaces 6, that are embodied as a recesses of the disk or as spaces between blocking bodies 8 arranged on the disk 7.

Furthermore, a part cooperating with the disk 7 with the spaces 6 is arranged inside a hollow space or recess inside the end part 9 of the bottom stay of the bicycle. This hollow space has an opening towards the inside of the bottom stay. The lock comprises a bolt 5 that is displaceable inside a channel 5′. The bolt 5 is preferably displaceable along is heart line that preferably aligns with the heart line of the channel 5′.

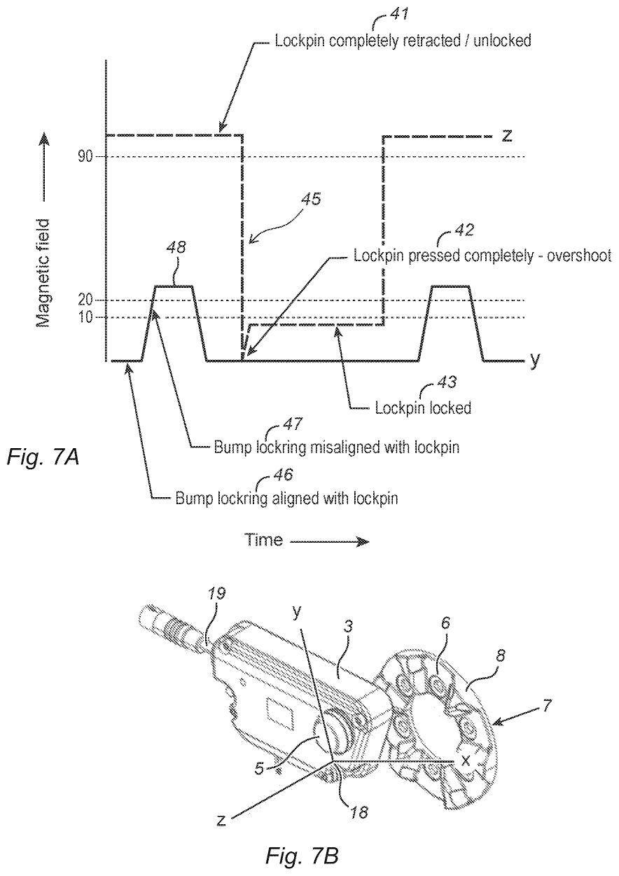

A general functioning of the lock is performed by the bolt 5 being displaceable between at least a blocking state 43 and an unblocking state 41 (refer also to FIGS. 7A-B). In the unblocking state, the bolt 5 is fully extended out of the channel 5′ in the direction away from the bicycle or the ring 7. In the blocking state, the bolt 5 is blockingly inserted into 1 of the receiving spaces 6, such as in between 2 successive blocking bodies 8 of the ring 7. Further states of the latch, and related features of the lock are disclosed with reference to FIGS. 7A-B.

Inside the hollow space of the bottom stay, a housing 3 of the lock is arranged. This housing comprises the channel 5′ with the bolt arranged therein as well as functional parts for operating lock. Generally, the functional parts for operating lock comprise a PCB 52′ mounted lock control unit 52. The PCB also comprises a location sensor, such as a hall sensor, such as a 3D hall sensor 18 for determining of a location of the 5 relative to the sensor 18. To provide or improve measurement signals for the 3D hall sensor 18, the bolt 5 comprises a magnet 19 that is arranged in the body 12 of the bolt. The processing device is also configured for driving of a latch actuator preferably embodied as a solenoid 30. A connector 14 is connected to a wire 17 that connects the lock with other subsystems of the bicycle. The wire 17 comprises wires to provide the lock with electrical energy and wires to provide the lock with data communications, such as preferably implemented as a can bus to the other subsystems of the bicycle.

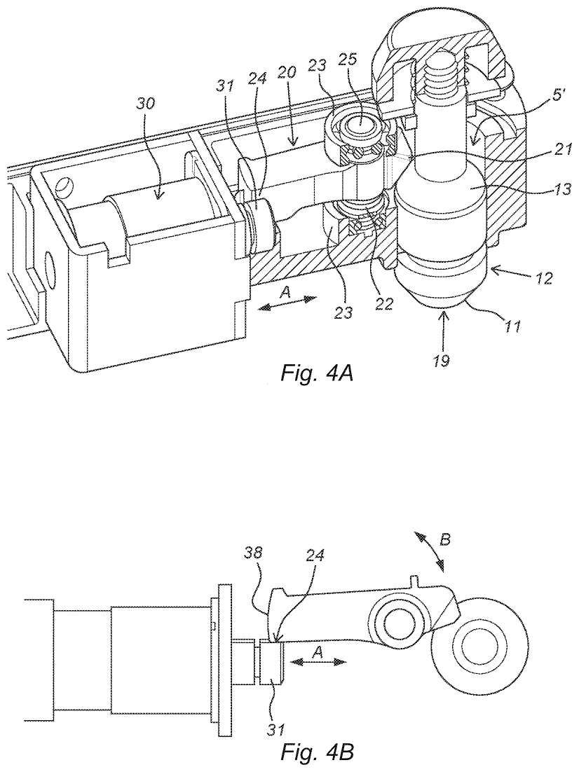

The lock 2 is controlled from the main controlling computer of the bicycle. To this end, the lock control unit 52 of the lock that is embodied on the circuit board 52′, controls the solenoid 30 for each unlocking of the bolt 5 by means of providing power to the solenoid 30 that is also obtained via the connection 17. The solenoid is configured to be in the state of FIGS. 4A-B without being powered by the lock control unit 52. This means that an operating end 31 of the solenoid is kept in the state under bias, such as by means of internal spring (not shown). When the solenoid is powered by the lock control unit 52, operating and 31 of the solenoid will be drawn inwardly toward the solenoid device 30 such that the latch 20 may pivot around the pivot axle 25. These preferred action is caused by a latch biasing device 22 preferably comprising a spring, for biasing the latch towards the election states. This spring 22 comprises a set part 22′ engaging with the latch for biasing the latch towards its unlatching state.

The solenoid 30 releases the latch 20 which causes the bolt 5 to be released to allow a displacement motion of the bolt 5. The latch 20 is arranged to engage with the operating end 31 of the solenoid. This operating end 31 of the solenoid as shown in FIGS. 4A-B, keeps the latch in the blocking state. In this blocking state, the latch engages with the bolt 5, in particular with a blocking surface 13 of the bolt 5. Also, the bolt 5 is arranged in the blocking state as depicted in FIGS. 4A-B.

Upon the latch biasing towards its unlatching state, the tip 21 of the latch releases the surface 13 of the bolt 5 in order to allow the bolt 5 to displace outwardly, away from the receiving space thereby releasing the lock. To this end, the bolt 5 is provided with biasing means, preferably embodied as a spring, 39. This spring 39, biases the bolt 5 towards the unblocking state 41. When this happens, the thick cylindrical body of the bolt 5 keeps the tip 21 of the latch pushed away such that the latch remains in the unlatching state and that the latch actuator remains in the releasing state, thereby pushing against the land surface 38 of the latch.

In the opposite direction, when the bolt 5 is pushed inward by a hand or a foot of the rider of the bicycle, the thick cylindrical body of the bolt is displaced and the tip 21 of the latch reaches the slanting surface 13 of the bolt, thereby allowing the latch to pivot from the latching state to the unlatching state. With this, the end surface 38 of the latch moves away from the pushing end part 31 of the actuator or solenoid 30 that is thereby allowed to spring back to keep the latch in the latching state. As the latch in the latching state keeps the bolt in the blocking state, lock remains locked until the latch actuator or solenoid is activated again to recede.

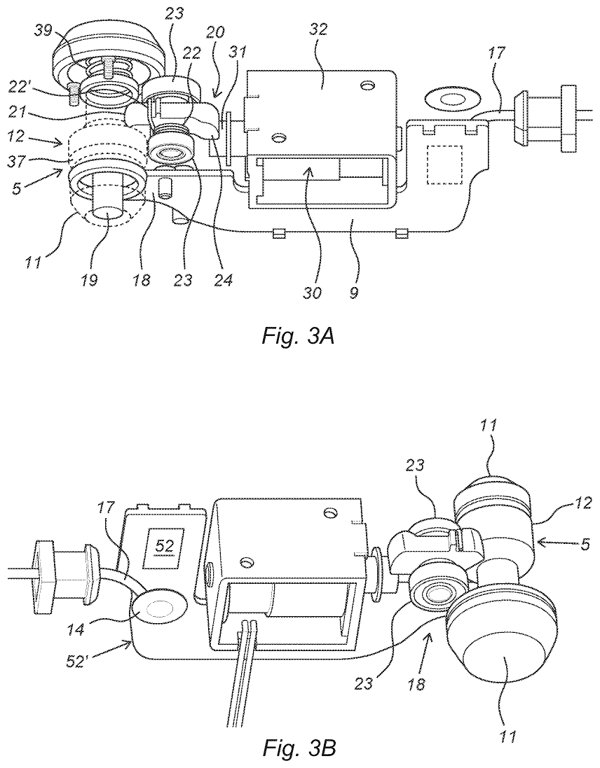

Preferably, the bolt 5 is provided to with a slot 37 (FIGS. 3A-B) in order to receive the latch in the unblocking state of the bolt. Such preferred embodiment provides for the prevention of inadvertently pushing in of the bolt by a rider, passenger or bystander. Such embodiments also requires activation of the latch actuator or solenoid during such pushing in of the bolt by a rider in order to allow for locking of the bicycle.

The hall sensor in a lock according to an embodiment according to the present invention preferably is a 3D hall sensor. With this, magnetic fields along several axes may be measured and detected. It is preferred that both the position of the bolt 5 may be detected with such a hall sensor and that a position of a body 8 the ring 7 may be detected relative to the hall sensor. These are distinct measurements to be performed by the hall sensor depending on an operating state the lock control unit 52 is operating in and/or determining to be relevant for performing measurements. The magnet 19 that is arranged in the body of the bolt provides a magnetic field based on which the hall sensor can perform a location determination of the bolt relative to the sensor. The location determination of the respective parties 8 of the ring 7 are performed based on a preferred magnetization quality of the bodies or based on a preferred presence of at least one magnet in such bodies 8

In reference to FIG. 7 A, signal levels of measurements are depicted in the graph. In reference to FIG. 7 B, the orientation of a coordinate system is provided with the 3D hall sensor generally at the origin. Signal level 41 indicates a positioning of the bolt 5 in the unblocking state or in the retracted position. This is generally the position in which it is kept under bias by the spring 39.

When the latch is pushed in by the rider of the bicycle, the rider gives an indication to the bicycle that the bicycle is to be locked. If the bolt 5 remains blocked against a body 8 of the ring, there is no alignment with the bolt and a receiving space 6. The pushing against the bolt still provides a displacement of the bolt away from the unblocking state, and as such, this displacement to a position generally indicated by 45, may be detected by the hall sensor and communicated by the lock control unit to the central controlling computer of the bicycle that it is intended to lock the bicycle. As such locking is blocked by the body 8 of the ring, the bicycle may provide feedback to the user by means of a sound or light feedback or even by feedback via a mobile app on a mobile device of the user. An advantage of such a feedback is that the user may be informed of such blocking of the bolt by such body and therefore of the need that a correction for locking is needed.

A further level 43 of the sensor indicates a blocking state of the bolt 5. In this blocking state, the latch keeps the bolt 5 blocked relative to the channel which means that the lock is in a locked state. This is a stable state until the latch gets released by the latch actuator. If the latch gets released by the latch actuator, the bolt 5 will return towards the unblocking state with a level 41 sensor signal.

When the bolt 5 is in the blocking state, it is possible to further push the bolt into the channel thereby urging the bulk to reach further into the receiving space 6. With this, it is possible to provide such signal central controlling computer as an operating input, such as a button press. It is considered that this button press like input by means of pushing the bolt into the channel to its deepest point and providing the sensor signal to the central controlling computer is used for the central controlling computer to interpret this as a confirmation to unlock the lock after the bicycle receiving another input that the bicycle is to unlock, such as the nearby presence of the mobile device of the user.

As an alternative to detecting of a displacement to the position generally indicated by 45, the hall sensor 18 may detect a signal level 48 or a signal level 47 of the other graph in FIG. 7 A. This level 47 or 48 indicates the presence of a body 8 at or near the sensor 18. As the mutual orientation of the signals in FIG. 7 A indicates, it is possible to push in the to the blocking state only, when the signal has a level 46 indicating that there is no body 8 of the ring 7 near the sensor and thus near the bolt 5.

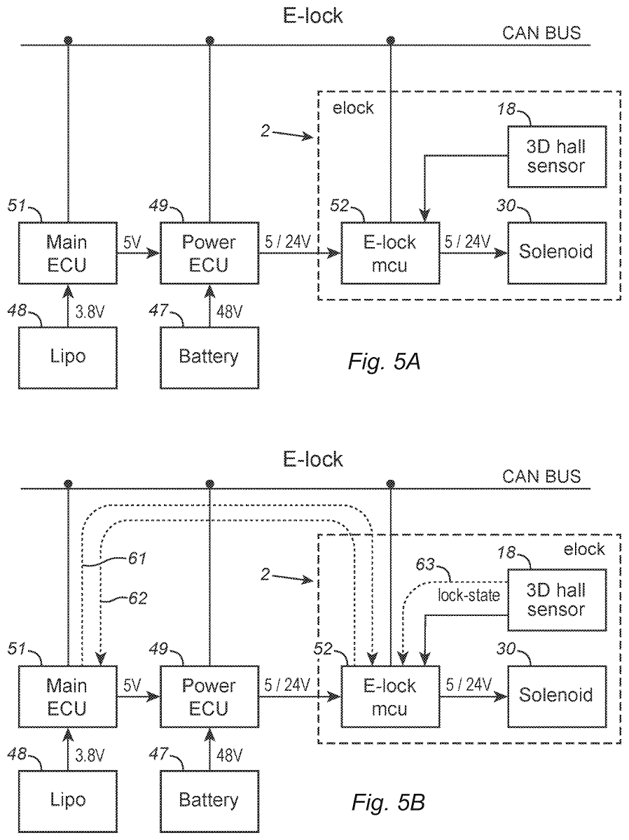

FIGS. 5A-B shows a schematic representation of an embodiment of bicycle components and/or subsystems that are functional in the operating of the lock of the bicycle. Of the lock 2, the lock control unit 52, the latch actuator 30 and a 3D hall sensor 18 are shown.

During monitoring of the position of the bolt 5 and/or ring 7, measuring signals of the hall sensor 18 are provided to the lock control unit 52 for processing thereof for the purpose of providing input for assembling a control signal to control the solenoid 30. The lock comprises a wired input 17 that is connected to a power in the data communication bus 4′ of the bicycle. This data communication bus is preferably embodied according to a CAN bus configuration and/or specification. In the lock control unit 52 receives looking instructions from outside the lock that are embodied as release instructions or unlock instructions. FIGS. 5A-B furthermore shows the central controlling computer 51 having a dedicated battery 48 of 3.8 V with a further control unit 49 taking up a power source for 48 V from a drive battery 47 of the bicycle. This further control unit 49 transforms the 48 V of the drive battery into a 24 V electricity source for the lock. In case of a full depletion or removal of the drive battery of the bicycle, it is provided that the solenoid of the lock may be powered by a fivefold signal coming from the central controlling computer as an emergency measure. However, the preferred 24 V signal from the further control unit 49 provides a preferred power level to drive the solenoid accurately and fast during daily usage.

Also operations of the blocking of the local are indicated generally in FIGS. 5A-B. When the rider pushes the bolt of the lock, the bicycle lock locks and the lock control unit 52 provides a message 62 to the central controlling computer to confirm locking of the lock. Preferably, this is performed upon the hall sensor 18 providing a signal 63 confirming the bolt to being and remaining in the blocking state.

In the other direction, the main controlling computer 51 provides and unlocking message 61 to the low control unit 52 up on receiving an authentication of the rider, with preferably a further confirmation of the intention to unlock by the rider.

Such authentication and/or identification in itself with proximity determination is one option of allowing the central controlling computer to unlock the bicycle. It is also preferred that a further operation by the rider is performed, such as an operation indicating the desire to ride, pressing a button at the handlebar of the bicycle providing instruction to the central controlling computer or pushing the bolt of the lock further in, providing the above indicated feedback to the central controlling computer by means of bolt detection level 42 by the 3D hall sensor of the lock. Another way of indicating the desire to start riding after authentication is by rotating the wheel relative to the bicycle. Such rotation may be detected by the hall sensor of the lock by detecting that both the bolt is in the blocking state and that a body of the ring is being pressed against or brought adjacent to the bolt. A further specific option is that the user provides a repetition of such movement such that the low control unit may identify such repetition of a body of the ring approaching and moving away from the bolt. Authentication of a rider may be performed based on other inputs, such as inputting of a pin code with a touch button such as a touch button and a handlebar of the bicycle. Another way of providing authentication is by means of a key fob that is preferably pre-authenticated.

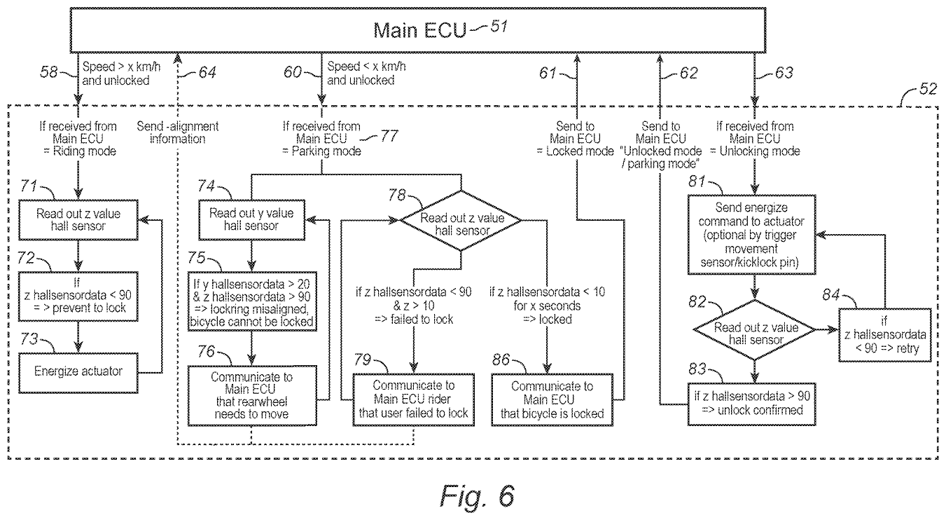

FIG. 6 provides a flow according to an embodiment of the present invention. Controlling according to this embodiment is performed by the lock control unit 52 in communication with the central controlling computer 51. The flow is explained in relation to distinct so-called operating modes of the bicycle. A first operating mode is the riding mode in which riding is performed and in which the lock is supposed to be unlocked and is supposed to be kept unlocked. A second operating mode is the parking mode in which it is preferred that the logging mode is used. A first operating mode is the unlocking mode in which it is envisaged that the bicycle is in the process of being unlocked.

Riding mode of the bicycle is preferably signaled to the lock control unit 52 by means of a message 58 from the central controlling computer 51. This message preferably instructs the lock control unit to perform the following steps. In step 71, the Z value of the hall sensor is monitored. The Z value of the hall sensor pertains to the location of the bolt 5 in the channel 5′. During riding mode, the preferred position of the bolt is in the unblocking state corresponding with level 41 of the sensor as indicated in the above. If during riding mode, the bolt were to be pressed, and the tip 19 of the bolt were to reach into a receiving space, the tip of the bolt were to come into collision with 1 of the bodies 8 of the ring 7. This could cause undesired breaking of the bicycle and/or damage to the lock. In order to prevent this, the following steps are performed. If a level of the hall sensor falls below a predetermined value, such as a value below 90% of its range, it is determined in step 72 that the lock has to remain unlocked.

Subsequently, in step 73, the latch actuator preferably embodied as the solenoid 30 is energized such that the tip 31 of the solenoid leaves the location of the and 24 of the latch. Due to the biasing action of the spring 22, the latch will be prevented from reaching the latching state and thus be prevented from keeping the bolt in the blocking state. Due to the biasing action of the spring 39, the bolt will be urged outwardly such that it will not block in conjunction with a body 8 of the ring 7. According to an alternative embodiment, with the slot 37 in the bolt, the bolt may be retained in the unblocking state by actually keeping the latch in the latching state during a period that the lock is to remain unlocked.

Parking mode of the bicycle is preferably signaled to the lock control unit 52 by means of message 60 from the central controlling computer 51. Parking mode according to the present embodiment is a mode in which the bike is supposed to be locked preferably when left alone. In step 74, the hall sensor is monitored. In step 75, if the hall sensor indicates, such as by means of a Z value thereof, that the bolt is well above or an mistakenly above a level that it could be in the blocking state, such as above 20%, above 30%, about 40% or above 90% of the range thereof, and the hall sensor indicates, such as by means of a Y value thereof, that a receiving space value is above baseline, such as above 5%, such as above 10%, such as above 20% of the range thereof, it is determined that a misalignment of the receiving spaces relative to the bolt occurs and the bicycle cannot be locked, at least not directly by pressing the bolt. If such determination is made, a message 64 for the central controlling computer 51 is assembled to indicate that situation, and thereby to indicate that the rear wheel is to be rotated in order to align a receiving space with the bolt. Subsequently, the central controlling computer 51 preferably outputs a warning signal indicating this to the rider. In case of a visual feedback option, such as via the mobile app or a display of the bicycle, it is envisaged that an indication of alignment between either adjacent receiving space is output and that signal changes that occur due to a rotation of the wheel are indicated in the visual feedback option. With this, the rider may be provided with a visual indication of alignment as soon as such alignment is reached.

In step 78, the Z value of the hall sensor is read out. In case it is determined, after pressing of the bolt, that the Z value has dipped below and blocking level, such as on hundred percent of its range, but thereafter remains higher than the level of the blocking state of the bolt, such as higher than substantially 10% of its range, in step 79, a message is assembled for the central controlling computer indicating that the lock is not locked. Based on the receipt of such message, the central controlling computer 51 feedback to the user that an attempt to lock the lock has not resulted in a locked lock switch feedback is preferably given visually, by means of an alarm sound, or by means of an output from the application on the mobile device, such as an alarm sound and/or a notification. With this, the user is informed that his attempts to kick in the lock has failed to lock and that the bicycle is at risk when left alone.

In case it is determined that the hall sensor data remains substantially at blocking state level, such as below for instance substantially 10% of its range, it is determined that the lock has been locked and a confirmation message 61 is assembled to be sent to the central controlling computer 51 of the bicycle. In case the central controlling computer 51 of the bicycle receives this message, a confirmation sound or light effect is given, or a sound or notification is provided by the application on the mobile device.

In looking mode of the bicycle is preferably signaled to the lock control unit 52 by means of message 63 from the central controlling computer. This message generally has the meaning of indicating to the lock control unit 52 that the central controlling computer received an authentication of the user, preferably with an additional in tension indication of the user to wants to unlock the lock of the bicycle. Subsequent to receiving such message 63, in step 81, the lock control unit 52 provides power to the latch actuator or solenoid 30 such as by means of actuating a switch. Subsequently, in step 82, the location of the bolt is monitored by means of the hall sensor, preferably the Z value thereof.

If the Z value reaches a value corresponding with the unblocking state, such as above 90% of the range thereof, it is preferably assumed that the bolt left the receiving space and that the locus been locked. A confirmation message is assembled in step 83 and sent to the central controlling computer 51. If it has been determined that the location of the bolt remains at a position corresponding with a value below the unblocking state, it is assumed that the lock did not unlock and the methods returns to step 81.

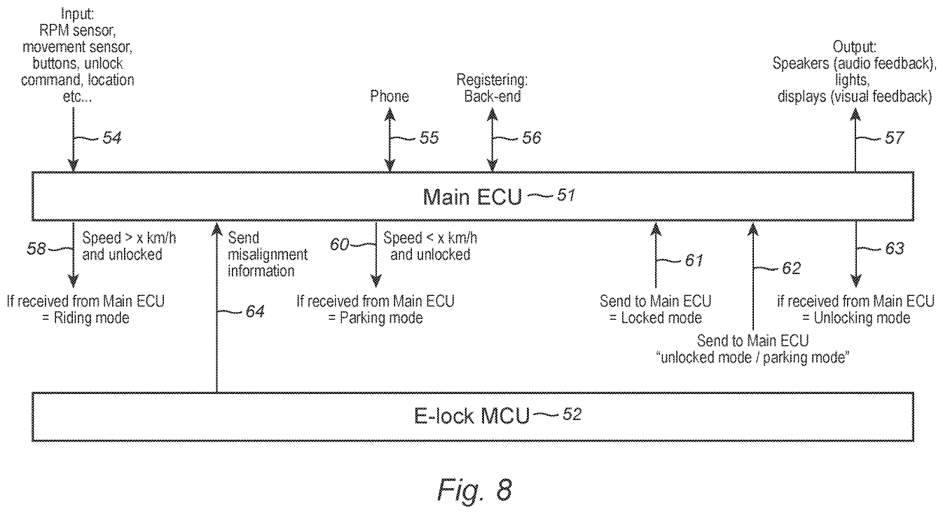

An alternative embodiment is described in relation to FIG. 8. According to this embodiment, the central controlling computer 51 is in communication with the lock control unit 52 as well as with a number of bicycle sensors 54, a mobile device 55, a registering back end server 56 as well as with output devices of the bicycle. The messages 58, 60, 61, 62 and 63 are similar to the messages of the embodiment according to FIG. 6. As such, the present embodiment provides additional information relating to features of sensor input and feedback output. It is provided that the main controlling computer receives input from or monitors sensors with respect to rotations per minute of the drive motor of the bicycle, a movement sensor or omnidirectional G sensor, control buttons for providing input to the central controlling computer, such as 2 or 4 buttons arranged at the handlebar, location determining sensors, such as mobile networks based location sensors, wideband location sensors or location determination by means of a Bluetooth signal. Furthermore, central controlling computer of the bicycle connects with a phone, preferably running a bike controlling application, such as for controlling input information or parameters used for determining whether a lock is to be locked or unlocked. Bicycle might be registered with a back end server for tracking of the bicycle when the bicycle has been removed while locked. For this, the location of the bicycle is 1 of the data points that is monitored and transferred to the back end server.

The bicycle has numerous outputs 57, such as at least one loudspeaker for your feedback rider or other persons, such as for providing of a warning that the bicycle is locked for an unauthorized person touching the bicycle, such as is determined when the authentication of the rightful rider is not present. When the bike is locked and moved, an audible signal is preferably provided to warn the surroundings as well as a preferably flashing visual signal is provided to warn the surroundings.

Elevator, all The bicycle is controlled by a central controlling computer or central board computer controlling basically the whole of the operations of the bicycle that are controlled electronically. The bicycle is controlled by the rider by means of buttons providing input to the central controlling computer, or by means of an app on a mobile device having communication with the central controlling computer. Such app preferably also provides authentication of the rider relative to the central controlling computer. To this end, the central controlling computer is provided with communication means to communicate with the mobile device of the rider, such communication means including mobile communication means, such as cellular, Wi-Fi, wideband or Bluetooth. With this, the proximity of the user relative to the bicycle may be determined directly via the radio connection or indirectly via GPS. If the proximity of the user relative to the bicycle is determined, the user may be authenticated with the use of the app.

A further preferred consideration is that the electrical energy that is used as the source of electrical energy for the lock is formatted in this further processing unit 16. It is preferred that the shifting motor is provided with electrical power having a third voltage between a first voltage for the central controlling computer and connected subsystems and a second voltage for the drive motor. This second voltage is preferably anywhere between 12 and 36 V, preferably about 24 V. Also an bicycle shifting device of the bicycle that is arranged at the other side of the wheel is provided from this electricity source with this voltage. Such intermediate voltage provides advantages of providing enough power for such bicycle shifting device and/or lock with a relatively low current.

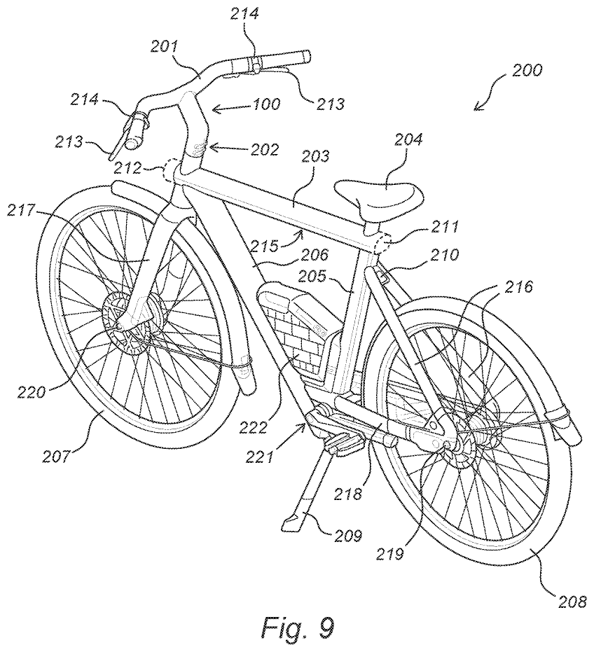

FIG. 9 shows a schematic overview of a bicycle 200 according to the invention. The bicycle 200 comprises a frame comprising a top tube 203, a seat tube 205, a bottom tube 206, a pair of seat stays 216, and a pair of chain stays 218. At the rear axis 219 a rear wheel 208 is rotatably arranged. The rear wheel may be powered by a used via a crankset 221. In order to drive de bicycle 200, the front side of the bicycle may comprise a handlebar 201, which may be rotatable with respect to the head tube 202 of the bicycle. The handlebar 201 may rotate the front wheel 207 which is arranged rotatably on a front axis 220. Said front wheel 207 may be held into place by means of the fork 217 which is rotatably coupled to the handlebar 201 of the bicycle 200. The handlebar 201 may be provided with a brake system 213 for allowing a user to apply a braking force. The handlebar 201 may comprise a first control unit 100, preferably arranged in a stem of the bicycle. Said first control unit may allow the accessory cables of the electronic accessories of the handlebar to be routed at least partially, preferably substantially entirely inside the frame of the bicycle 200. The first control unit 100 allows to reduce the amount of cables running through a steerer tube. One or more optical feedback units 214 may be arranged on and/or in the handlebar 201 for providing the user with optical feedback related to a bicycle status. Inside the bottom tube 206 a primary battery may be arranged for driving at least one electric motor which is arranged in the front axis 220 and/or rear axis 219. Optionally, a secondary battery 222 may be provided for extending the range of the bicycle 200. The primary battery inside the bottom tube 206 and/or the secondary battery 222 may be charged via a charging port 210 of the bicycle 200. The charging port 210 is arranged on a rear side of the bicycle in order to be easily accessible for a user. In this particular embodiment, the charging port 210 is arranged between the pair of seat stays 216 and attached to the seat tube 205 of the bicycle 200. In order for easily connecting the bicycle 200 to an external service device a service port 215 may be provided. In this embodiment the service port 215 is provided on a bottom side of the top tube 203 of the bicycle. Inside the top tube 203 at least one bicycle control unit may be provided. It is imaginable that at least one exposed exterior surface of at least one frame part comprises at least one antenna system. Said antenna system may be directly or indirectly mounted to said bicycle frame 203, 205, 206, 212, 216. The seat tube 205 further accommodates the seat post which may be attached to the saddle 204 of the bicycle 200. In order to increase the visibility of the user of the bicycle 200 during the evening or in the night time, the bicycle 200 may be provided with a front light module 212 and/or a rear light module 211. Said front light module 212 and rear light module 211 may allow for dynamic light patterns and/or for emitting light in at least a left and/or right direction. The bicycle 200 as shown in this figure is merely illustrative for the components thereof. It is explicitly noted that some aspects of the bicycle 200 as shown in this figure may be chosen by way of design. In particular shapes of the light modules 212, 211 may at least partially be shaped by design. Moreover, the shape of the tubes 202, 203, 205, 206 of the bicycle may also at least partially be chosen by way of design. Hence, the aesthetical appearance of the depicted embodiment are matters of design choice and can be varied or eliminated as desired.

The above-described inventive concepts are illustrated by several illustrative embodiments. It is conceivable that individual inventive concepts, including inventive details, may be applied without, in so doing, also applying other details of the described example. It is not necessary to elaborate on examples of all conceivable combinations of the above-described inventive concepts, as a person skilled in the art will understand numerous inventive concepts can be (re)combined in order to arrive at a specific application and/or alternative embodiment.

The ordinal numbers used in this document, like “first”, “second”, and “third” are used only for identification purposes. Hence, the use of expressions like a “second” component, does therefore not necessarily require the co-presence of a “first” component. By “complementary” components is meant that these components are configured to co-act with each other. However, to this end, these components do not necessarily have to have complementary forms. The verb “comprise” and conjugations thereof used in this patent publication are understood to mean not only “comprise”, but are also understood to mean the phrases “contain”, “substantially consist of”, “formed by” and conjugations thereof.

It will be apparent that the invention is not limited to the working examples shown and described herein, but that numerous variants are possible within the scope of the attached claims that will be obvious to a person skilled in the art. The aesthetical appearance and design of the working examples or details thereof, in particular as shown in the appended figures, is not technically determined, unless indicated otherwise, and is merely incorporate to demonstrate and clarify the inventive concept(s) described herein. Hence, the aesthetical appearance of the depicted embodiments are matters of design choice and can be varied or eliminated as desired. The owner of this patent document does moreover not disclaim any other rights that may be lawfully associated with the information disclosed in this document, including but not limited to, copyrights and designs associated with, based upon, and/or derived from the appended figures.

The present invention is described in the foregoing on the basis of preferred embodiments. Different aspects of different embodiments are expressly considered disclosed in combination with each other and in all combinations that on the basis of this document, when read by a skilled person of the area of skill, fall within the scope of the invention or are deemed to be read with the disclosure of this document. These preferred embodiments are not limitative for the scope of protection of this document. The rights sought are defined in the appended claims.

1. A bicycle with a central controlling computer for controlling subsystems of the bicycle the bicycle comprising a lock, the lock comprising:
a housing,
a bolt having a blocking state and an unblocking state providing a blocking action in the blocking state with which the bicycle is locked,
at least one bolt spring constantly co-acting with the bolt for urging the bolt towards the unblocking state, a channel for therein arranging of the bolt,
a latch having a latching state and an unlatching state for, in the latching state of the latch, keeping the bolt in the blocking state,
a latch actuator said latch actuator having a blocking state and a releasing state for releasing the latch,
wherein the bolt in the blocking state is in cooperation with a receiving space defining a state of cooperation in which the bolt and the receiving space locks the bicycle,
a lock control unit for controlling the lock and for communication with the central controlling computer,
wherein the lock control unit is configured to, based on an action and/or a status of a rider of the bicycle, provide a release actuation signal for releasing the latch to allow urging the bolt towards the unblocking state by means of said at least one bolt spring.

2. The bicycle according to claim 1, wherein at least a part of said at least one bolt spring surrounds the bolt.

3. The bicycle according to claim 1, the lock comprising a sensor providing sensor signals for detecting a position of the bolt relative to the sensor.

4. (canceled)

5. The bicycle according to claim 3, wherein at least one sensor is a Hall sensor wherein said sensor is mounted onto or within said housing.

6. The bicycle according to claim 3, wherein the bicycle comprises at least one processor configured to monitor the sensor signals and functional to interpret the sensor signals as input for locking instructions or unlocking instructions.

7. The bicycle according to claim 6, wherein the sensor signals are interpreted such that the bolt is respectively determined to be:
in the unblocking state when the position of the bolt is fully retracted,
in the blocking state when the position of the bolt is held by the latch when the latch is in the latched state,
in a fully pressed in state, when the bolt is in a fully pressed in state during a press in operation by a rider,
in a wheel rotation induced state.

8. The bicycle according to claim 6 in which the sensor signals are interpreted such that the receiving space is respectively determined to be:
aligned with the bolt,
misaligned with the bolt,
in an intermediary position between aligned and misaligned.

9. The bicycle according to claim 6, wherein the lock control unit and/or the central processing unit is configured to determine the relative position of the bolt and/or at least one receiving space with respect to the housing.

10. The bicycle according to claim 1, wherein the latch is a hinging latch hinging about a pivot.

11. The bicycle according to claim 10, wherein the pivot is situated in between in the latch actuator and the bolt and/or wherein the pivot divides the latch into a latch actuator facing section and a bold facing section, wherein the length of said latch actuator facing section exceeds the length bolt facing section.

12. (canceled)

13. The bicycle according to claim 10, wherein the pivot has a pivot axis which runs substantially parallel with a longitudinal axis of the bolt and/or a displacement direction of the bolt.

14. The bicycle according to claim 1, wherein the maximum rotation angle of the hinge arounds its pivot is limited to 30 degrees.

15. The bicycle according to claim 1, wherein the lock comprises at least one limitation cam for limiting a displacement of the latch and/or wherein the latch is provided with a latch biasing device for biasing the latch towards the unlatching state and/or in which the latch actuator is generally substantially directed at the bold along a heart-line of the latch actuator latch and latch actuator substantially form a linear arrangement.

16. (canceled)

17. (canceled)

18. The bicycle according to claim 1, wherein the central controlling computer comprises a receiving module for receiving of user input and/or bicycle speed related input, wherein the central controlling computer is configured to communicate with and/or to instruct the lock control unit based upon the input received.

19. The bicycle according to claim 1, comprising at least one processor arranged for assembling locking instructions or unlocking instructions based on a combination of sensor signals as input or user input:
an unlocking instruction in case of a respective user input,
an unlocking instruction in case of a respective user input in combination with a sensor input, and/or
an unlocking instruction in case of a user input in combination with a sensor input.

20. The bicycle according to claim 1, comprising at least one feedback device for providing rider feedback based on sensor information and/or lock related information feedback by a display or feedback via and app that is functional on a mobile device of the rider, wherein the rider feedback comprises feedback as to correctly locking of the bicycle lock, no locking of the bicycle lock due to a misalignment of the bolt with the receiving space, correctly unlocking of the bicycle lock, and/or not unlocking of the bicycle lock.

21. (canceled)

22. The bicycle according to claim 1, wherein the lock comprises at least one locking plate fixedly attached, either directly or indirectly, to a wheel of the bicycle, wherein the locking plate comprises bolt receiving spaces mutually separated by blocking bodies arranged on said locking plate, wherein each blocking body is provided with inclined side walls facing adjacent receiving spaces to facilitate guiding of the bold into a receiving space.

23. (canceled)

24. The bicycle according to claim 1, wherein the bolt has a tapered end section facing the at least one receiving space to facilitate guiding of the bolt into a receiving space and/or wherein an end section of the latch, facing the bolt, has an inclined bolt contact surface with respect to a longitudinal axis of the bolt and/or a displacement direction of the bolt and/or wherein the bolt has an inclined latch contact surface with respect to a longitudinal axis of the bolt and/or a displacement direction of the bolt.

25-27. (canceled)

28. The bicycle according to claim 1, wherein the latch comprises a latch actuator contact surface, which runs substantially parallel with a longitudinal axis of the bolt and/or a displacement direction of the bolt and/or wherein at least one bolt spring co-acts with a stationary part of the lock and/or wherein the lock control unit and the central processing unit are configured to two-way communications with each other.

29. (canceled)

30. (canceled)

31. A lock for use in a bicycle according to claim 1.
